(19) United States
(12) Patent Application Publication
(10) Pub. No.: US 2006/0082109 A1
(43) Pub. Date: Apr. 20, 2006

(54) METHOD OF MAKING AN AUTOMOTIVE TRIM ASSEMBLY HAVING AN INTEGRATED AIRBAG DOOR

(76) Inventors: Michael J Hier, Milford, MI (US); Glenn A Cowelchuk, Chesterfield Township, MI (US); Randy S Reed, Fair Haven, MI (US); David Dooley, Troy, MI (US); Todd L DePue, Brighton, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/904,033

(22) Filed: Oct. 20, 2004

(51) Int. Cl. B60R 21/16

(52) U.S. Cl. 280/732

(57) ABSTRACT

A method of making an automotive trim assembly includes injection molding a first curable polymer to form a substrate including a deployment door in a first shot of a molding operation. A cover is then formed on at least a portion of both the substrate and deployment door by injection molding a second curable polymer in a second shot of the molding operation. The cover includes an inner and outer layer of the second polymer having a substantially non-cellular structure and a core of the second polymer having a cellular structure between the inner and outer layers. At least one score line is formed in the substrate to define the deployment door therein. The score line may be formed during the molding operation or in a post-molding process, such as a laser scoring process.

### FIELD OF THE INVENTION

The present invention pertains generally to automotive interior trim assemblies and more particularly to trim assemblies having airbag doors for concealing and deploying an airbag.

### BACKGROUND OF THE INVENTION

Motor vehicles include an airbag system consisting of impact sensors, a system controller, an inflator, and the inflatable airbag cushions themselves. The inflatable airbag cushions are stored for deployment at a number of locations inside a motor vehicle and, when deployed into the passenger cabin in the event of a collision, protect the vehicle occupants from injury. For example, inflatable airbag cushions are stored at concealed locations behind deployment doors within the steering wheel for protection of the driver and in the instrument panel for protection of a passenger during a collision event. Airbag systems may also be provided in other trim assemblies throughout the vehicle.

Concealing each airbag cushion is a deployment door that forms an interior portion of the vehicle, such as a portion of the steering wheel hub, instrument panel or other trim assembly. Typically, the deployment door covers an opening through which the airbag cushion is deployed in the event of a collision. When the airbag cushion inflates, the deployment door is opened by the force applied by the inflating airbag cushion against the deployment door.

Designers of interior trim assemblies, however, have been challenged with providing effective deployment of an airbag cushion while providing a pleasing aesthetic appearance of the interior trim assembly through which the airbag cushion deploys. Designers of interior trim assemblies have also been challenged to provide such interior trim assemblies in a cost effective manner. In several designs, a trim assembly has a multi-portion construction, including a retainer portion, which comprises a significant part of the trim assembly, and a deployment door that overlies the airbag cushion located immediately behind the trim assembly. In many of these designs, the trim assembly has a visible seam having a low resistance to normal and shear stresses to allow the airbag cushion to deploy therethrough. This seam clearly distinguishes the deployment door from the retainer portion of the trim assembly and consequently detracts from the aesthetic appearance of the automotive interior.

Another consideration for designers of trim assemblies deals with preventing the deployment door from being ejected into the passenger compartment at a high rate of speed during the deployment of the airbag cushion. Many designs include a hinge mechanism located on the interior or back side of the deployment door adjacent the airbag cushion with one end coupled to the back side of the deployment door and another end coupled to a fixed support. The hinge mechanism is typically placed on the back side of the deployment door so that it is not visible from the passenger compartment and does not detract from the aesthetic appearance of the automotive interior.

For instance, several designs use a tether made of natural fibers, synthetic fibers, thermoplastic materials or other suitable materials, having one end coupled to the deployment door through adhesives, vibration or sonic welding techniques, or other methods. The opposed end of the tether is then attached to the airbag housing or other automotive support. In this way, the tether functions as a hinge that allows, or otherwise facilitates, pivotal movement of the deployment door so as to prevent the door from separating from the trim assembly when the airbag cushion is deployed.

Hinge mechanisms located on the interior side of the deployment door have some drawbacks. In particular, so as to accommodate the pivotal movement of the deployment door, the hinge mechanism may have a loosened or slack region when the airbag cushion is in the stored or non-deployed state. Consequently, the hinge mechanism is susceptible to hinge binding, which may lead to the improper functioning of the airbag system when actuated. Additionally, incorporating a separate hinge mechanism into the airbag system requires additional parts and labor which increase the overall cost of the trim assembly.

There is a need for an improved method of making an interior trim assembly having an airbag deployment door that enhances the aesthetic appearance of the automotive interior, increases airbag reliability and reduces the number of parts, labor and overall manufacturing costs.

### SUMMARY OF THE INVENTION

The present invention provides a method of making an automotive trim assembly having an integrated airbag deployment door that addresses these and other drawbacks of conventional airbag doors and which can be produced in an efficient and cost-effective manner. The trim assembly comprises a substrate having a front surface adapted to face an automotive interior and a back surface opposite to the front surface. An airbag system is stored immediately behind the deployment door and includes an airbag cushion for deployment through the trim assembly. A cover is molded onto at least a portion of the substrate and deployment door and includes an inner and outer layer of a polymer material having a substantially non-cellular structure and a core of polymer material having a cellular structure positioned between the inner and outer layers. The deployment door is adapted to open when the airbag is actuated so that the airbag cushion may expand into the passenger compartment. The cover is adapted to keep the deployment door attached to the trim assembly, so as to prevent the door from being ejected into the passenger compartment.

In one embodiment of the invention, the deployment door is defined by at least one score line and preferably a plurality of score lines formed in the backside of the instrument panel. The score lines may take an H-shaped pattern, a U-shaped pattern or other patterns so as to define the deployment door. The depth and type of the score lines may be configured so that the deployment door opens upon the airbag cushion applying a specified force to the back of the trim assembly. For instance, the depth of the score lines may be configured to extend entirely through the substrate or through the substrate and partially through the cover. Additionally, the score lines may be configured as continuous score lines or intermittent score lines.

A method of making the above-described trim assembly includes injection molding a first polymer to form a substrate in a first shot of a molding process and then injection molding a second polymer to form a cover in a second shot of a molding process. The cover includes an inner and outer layer of the second polymer material having a substantially non-cellular structure and a core of the second polymer material having a cellular structure positioned between the inner and outer layers. The score lines may be formed in the trim assembly during the molding process or in a post-molding process, such as a laser scoring process.

The invention provides a method of making an automotive interior trim assembly adapted to have an airbag deploy therethrough that increases airbag reliability and that reduces the number of parts and labor required for assembly thereof, thereby reducing overall manufacturing costs. The trim assembly also provides an aesthetically pleasing appearance and lacks visible weakened regions. These and other objects and advantages of the invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an automotive interior including several exemplary trim assemblies according to the present invention;

FIG. 2A is a cross-sectional view taken generally along line 2A-2A in FIG. 1;

FIG. 2B is a cross-sectional view similar to FIG. 2A depicting the inflation of the airbag cushion and opening of the deployment door;

FIG. 3 is a view looking from the back of the instrument panel illustrating an exemplary score line pattern;

FIGS. 4A-4D are cross-sectional views of the instrument panel illustrating possible depths of the score lines;

FIGS. 5A-5D are diagrammatic cross-sectional views of an injection molding operation for forming the trim assemblies of the invention; and

FIG. 6 is a diagrammatic cross-sectional view of a laser scoring process for forming the score lines in the trim assembly.

### DETAILED DESCRIPTION

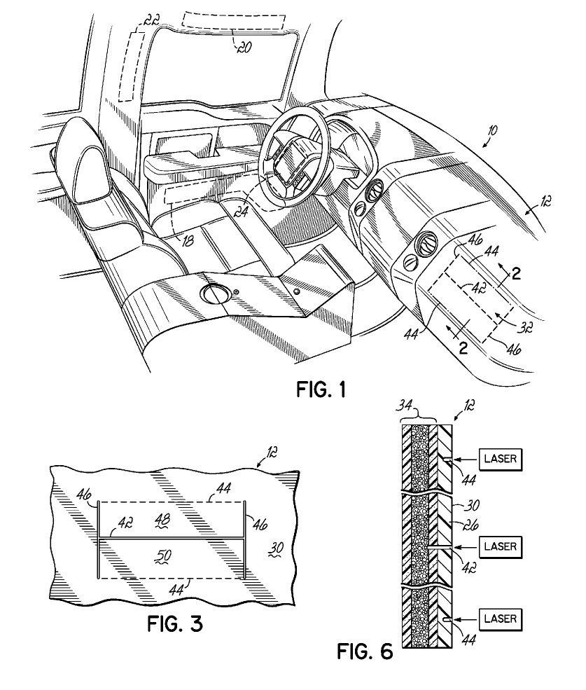

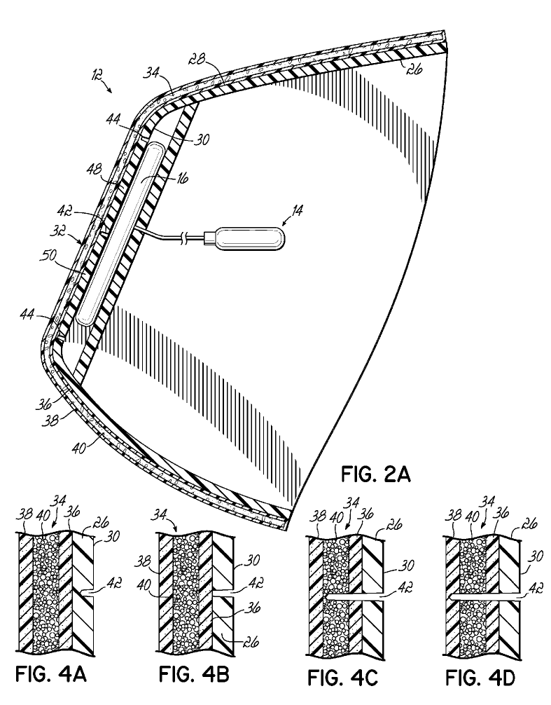

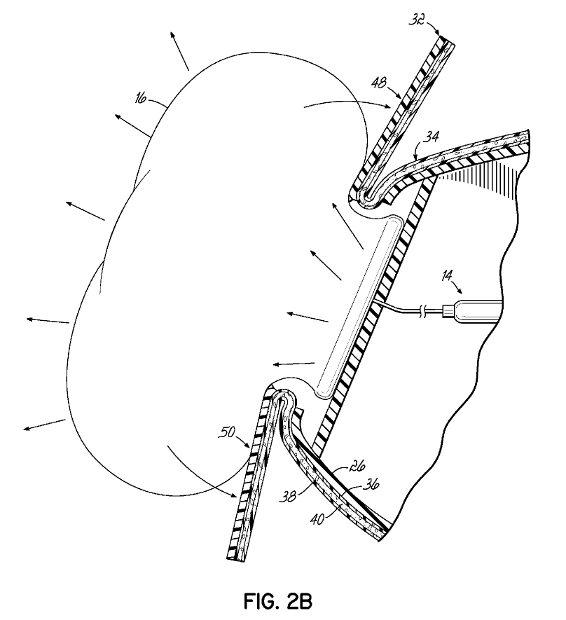

In reference to FIG. 1, an automobile 10 includes a number of exemplary trim assemblies, such as instrument panel 12, that cover the interior of the automobile 10 to provide an aesthetically pleasing environment and to enhance the comfort of the vehicle occupants. Instrument panel 12 is equipped with an airbag system 14 having an airbag cushion 16 adapted to be deployed through instrument panel 12 to protect the vehicle occupants (FIG. 2A). The various trim assemblies lining the interior of the automobile 10 are generally constructed in a similar fashion. Thus, although the following detailed description will be directed toward an instrument panel 12, those having ordinary skill in the art will recognize that the invention may equally apply to other trim assemblies in the automobile 10, such as door panels 18, roof panels 20, pillar trim panels 22, steering wheel hub panels 24, and other trim assemblies.

With reference to FIGS. 2A and 2B, instrument panel 12 includes a relatively rigid substrate 26, which forms at least a portion of the structural support, and defines the general shape of the instrument panel 12. The instrument panel 12 is secured to the interior of automobile 10, for example, by a bracket or mounting member (not shown) to position the instrument panel 12 in the forward portion of the passenger cabin. Substrate 26 includes a front surface 28 that faces the interior of the automobile 10 and a back surface 30 opposite the front surface 28 that is hidden from view when the instrument panel 12 is mounted to the automobile 10. The substrate 26 includes a deployment door 32 integrally molded with the substrate 26. As shown in FIG. 2A, airbag cushion 16 is located immediately behind the deployment door 32 in substrate 26 when in the stored or non-deployed state. The deployment door 32 is configured so that when the airbag system 14 is actuated, the deployment door 32 opens to allow the airbag cushion 16 to expand into the passenger compartment and protect the vehicle occupants therein, as shown in FIG. 2B.

Instrument panel 12 further includes a cover 34 that is integrally molded with the substrate 26. The cover 34 includes an inner layer or skin 36, an outer layer or skin 38, and a core 40 of a cellular material, preferably with a closed cellular structure, disposed between the inner and outer layers 36, 38. Alternatively, the cells of the core 40 may define an interconnected open-celled structure. Outer layer 38 has an exterior surface that is exposed and visible to vehicle occupants seated inside the passenger cabin when instrument panel 12 is mounted to automobile 10. The inner layer 36 may operate as a tie layer with the substrate 26. The cover 34 may be present across the full dimensions of the substrate 26 or a portion of the substrate 26 including deployment door 32 to provide a soft feel to the instrument panel 12. Typically, the appearance of the outer layer 38 is aesthetically pleasing and will match the decorative design of the automotive interior.

The instrument panel 12 is molded as a layered structure of different polymer materials by a multi-shot molding process, as described in more detail below. The substrate 26 may be made from a structurally rigid thermoplastic or thermoset polymer material like a thermoplastic polyolefin (e.g. polypropylene). The inner and outer layers 36, 38 and cellular material of the core 40 may be made from a thermoplastic polymer like a thermoplastic elastomer (TPE) compound or a polyolefin such as polypropylene. In this way, the instrument panel 12 has sufficient structural support while also having a decorative, soft feel aspect on the exposed surface of the instrument panel 12.

Advantageously, deployment door 32 is integrally molded with the substrate 26 and positioned so that airbag cushion 16 is immediately behind deployment door 32 when in a stored state, as shown in FIG. 2A. The deployment door 32 may be defined by at least one score line, and preferably a plurality of score lines in substrate 26. To this end, a plurality of score lines 42, 44 and 46 may be formed in the back surface 30 of the substrate 26. The score line 42 may function as a tear line or seam that separates when the airbag system 14 is actuated and the airbag cushion 16 expands, as shown in FIG. 2B. To this end, score line 42 is configured such that when the airbag cushion 16 expands, a tear forms through not only the substrate 26 but also through the cover 34 thereby providing the opening in the instrument panel 12 through which the airbag cushion 16 expands.

Score lines 44, on the other hand, may function as bend or hinge lines about which the deployment door 32 may pivot. Score lines 44 are configured such that when the airbag cushion 16 expands, the score lines 44 include at least a portion that does not tear completely through the cover 34. In this way, the cover 34 functions as a living hinge and allows the deployment door 32 to pivotally open, as shown in FIG. 2B. Additional score lines 46, which function as tear lines, are also provided along the sides of the deployment door 32 such that the score lines 42, 46 cooperate to define an H-shaped tear seam pattern, as shown in FIG. 3. The H-shaped pattern forms two deployment door panels 48 and 50 that adjoin along tear seam 42 and pivots along opposed hinge lines 44. The score lines 42, 46 may also be configured to define a U-shaped tear seam pattern (not shown) to define a single panel deployment door that pivots along a hinge line. As one of ordinary skill in the art will appreciate, the score lines may be configured in a wide variety of patterns so as to define deployment door 32.

The score lines 42, 44, 46 that define deployment door 32 represent, in essence, weakened sections of the instrument panel 12 such that when the airbag cushion 16 applies a sufficient force to the back surface 30 of the substrate 26, the deployment door 32 tears or otherwise separates from the substrate 26 and cover 34 along the score lines 42, 46 so that the airbag cushion 16 may deploy therethrough. The amount of force required to open the deployment door 32 along score lines 42, 46 may vary depending on the depth of the score lines and on the type of score line in the instrument panel 12. Those having ordinary skill in the art will recognize that the score line depth may be selectively determined or designed so that the deployment door 32 opens when the airbag cushion 16 applies a specified force thereto. To this end, and as shown in FIGS. 4A-4D, the score lines 42, 46, or at least portions thereof, may extend partially through the substrate 26, entirely through the substrate 26 or through the substrate 26 and part of the cover 34. Generally, the deeper the score line, the lower the force required to tear the substrate 26 and cover 34 to form an opening through which airbag cushion 16 may be deployed.

The type of score line also affects the amount of force required to open the deployment door. For example, the score lines may be continuously formed in the substrate 26, and possibly the cover 34, such that there are no unscored portions along the score line, such as that shown for score lines 42 and 46 in FIG. 3. Alternatively, the score lines may be intermittently formed in the substrate 26, and possibly the cover 34, so as to have scored portions and unscored portions adjacent one another, such as that shown for score lines 44 in FIG. 3. Generally, continuously formed score lines require less force to tear through the substrate 26 and cover 34 to open the deployment door 32. As one of ordinary skill in the art can appreciated, the length of the scored and unscored portions for intermittently formed score lines may be adjusted to affect the force at which the deployment door 32 opens.

Score lines 44, which form the hinge lines, preferably have a depth only partially through substrate 26, as shown in FIG. 4A. In this way, when the airbag system 14 is actuated, the substrate 26 and cover 34 bend about score lines 44 but do not become detached from instrument panel 12, thereby keeping deployment door 32 connected to the instrument panel 12. The score lines 44 may also be configured so that deployment door 32 tears or otherwise separates from the substrate 26 during deployment of the airbag cushion 16 (FIG. 2B). To this end, the score lines 44, or at least portions thereof, may extend entirely through the substrate 26 or through the substrate 26 and part of the cover 34, as shown in FIGS. 4B-4D. The depth of score lines 44 through cover 34 is however limited by the requirement that during deployment of the airbag cushion 16, the cover 34 is not completely torn through but includes at least a portion that remains in tact along score lines 44. This prevents the deployment door 32 from completely detaching from the instrument panel 12 and being ejected into the passenger cabin. As with tear lines 42, 46, score lines 44 may be formed in instrument panel 12 as continuous score lines or intermittent score lines as shown in FIG. 3. For either type of score line, however, there must be at least some portion of the cover 34 that remains coupled with the deployment door 32.

The instrument panel 12 constructed as described above has a number of advantages. One advantage is that when the airbag cushion 16 is in a stored state, the deployment door 32 is an integral part of the instrument panel 12, and is therefore not identifiable within the instrument panel 12. In this way, the invention provides a seamless trim assembly with airbag-deploying capabilities. The aesthetic aspects of the trim assembly are therefore not encumbered by incorporating the airbag system 14 therein and having the airbag cushion 16 deploy through the trim assembly. Another advantage is that the cover 34 functions as a hinge mechanism that serves to not only allow the deployment door 32 to pivotally swing open but also keeps the deployment door attached to the instrument panel 12 and therefore prevents the door 32 from being ejected into the passenger cabin when the airbag system 14 is deployed. Thus, a separate hinge mechanism is not required thereby reducing the number of parts and reducing the overall costs. Furthermore, because the hinge mechanism, i.e., at least the cover 34, is located on the front surface of the deployment door 32, as opposed to the more traditional location on the back side of the door, problems associated with hinge binding and possible malfunction of the airbag system 14 are eliminated.

Additionally, the multi-layered construction of the cover 34 provides sufficient strength to retain the deployment door 32 when the airbag system 14 is actuated. The multi-layered construction also prevents tears that initiate in the cover 34 along score lines 44 during deployment of the airbag cushion 16 from propagating completely through the cover 34. To this end, when a tear is initiated in one layer, such as inner layer 36, it may propagate completely through inner layer 36. To tear through the core 40 of the cover 34, however, the tear must be reinitiated in the core 40. If the core 40 is completely torn, the tear must then be reinitiated in outer layer 38. Thus to tear completely through the cover 34, multiple tears must be initiated in the cover 34. The multi-layered structure, therefore, reduces the likelihood of the deployment door 32 detaching from the instrument panel 12 when the airbag cushion 16 in deployed.

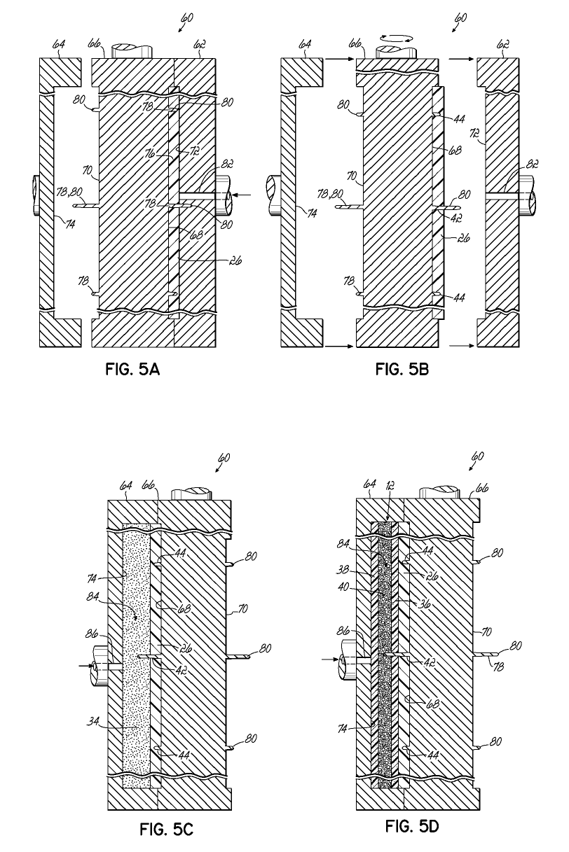

With reference to FIGS. 5A-5D, a method of making the instrument panel 12 of the present invention with a multi-shot process in an injection molding machine equipped with two independent injection systems for injecting different types of molten polymers will now be described. A single mold assembly 60 includes spaced-apart first and second members 62 and 64, and a mold core 66 situated between the members 62, 64. The mold core 66 has opposite first and second cavities 68, 70 each adapted to confront and mate with one of a corresponding first and second cavities 72, 74 defined in the members 62, 64. The mold core 66 is adapted to pivot so that the first and second cavities 68, 70 are confronting, in turn, with the first and second cavities 72, 74 to injection mold, in sequence, first the substrate 26, then the cover 34. While the first and second shots of the injection molding operation are described below with respect to the first cavity 68, it is understood that the first and second shots of the two-shot molding operation occur in the same fashion with respect to the second cavity 70.

As shown in FIGS. 5A-5B, the first cavity 68 of the mold core 66 is moved into alignment with mold cavity 72 and mated with the first member 62 to define a closed first shot mold chamber 76 defined by the combined volume of cavities 68 and 72. The mold core 66 includes movable slides 78, as is known in the art, for forming the tear lines 42, 46 and hinge lines 44 in the substrate 26. In particular, movable slides 78 include a projecting portion 80 that extends into the first shot mold chamber 76 and are adjustable so as to control the distance in which the projecting portion 80 extends into the first mold chamber 76. This length determines the depth of the score lines 42, 44, 46 in substrate 26. In a first shot of the molding operation, a molten polymer suitable for forming substrate 26 is injected through a channel 82 into mold chamber 76.

As shown in FIGS. 5B-5D, the first member 62 is moved away from the mold core 66 and core 66 is rotated so that the first cavity 68 carrying substrate 26 confronts and mates with the second cavity 74 to define a closed second shot mold chamber 84 about the substrate 26. The movable slides 78 may be adjusted so that projecting portions 80 extend beyond substrate 26 and into the second mold chamber 84. Movable slides 78 may be adjusted so as to control the distance in which projecting portion 80 extends into the second mold chamber 84. This length determines the depth of the score lines 42, 44, 46 in the cover 34. In a second shot of the two-shot molding operation, a molten polymer material having an additive blowing agent mixed therewith is injected through a channel 86 into mold chamber 84 to form the cover 34.

The injected molten polymer is activated, or foamed, as is commonly known in the art, by introducing a physical or chemical blowing agent into the molten polymer, generally prior to being injected into mold chamber 84. Generally, the blowing agent works by expanding the polymer of core 40 to produce a cellular structure having significantly less density than the polymer itself. The blowing agent may be any chemical agent that liberates gas when heated above a characteristic decomposition temperature (e.g. sodium bicarbonate that liberates CO₂ when heated above its decomposition temperature), any physical agent such as any gas (e.g. gaseous nitrogen), or any other known blowing agent. As the polymer cools and hardens, gas-filled bubbles originating from the blowing agent define the cellular structure throughout core 40 of a given density. Depending upon the molding conditions, the cell structure of the cured core 40 may either be closed or open. The polymer material of cover 34 may be a thermoplastic polymer like a thermoplastic elastomer or a polyolefin like polypropylene.

As the mold is cooled, portions of the molten polymer in contact with the second member 64 and the substrate 26, held by the first cavity 68, form the inner layer 36 on the surface of substrate 26 and the outer layer 38 on the exposed surface of the finished instrument panel 12. The inner and outer layers 36, 38 are substantially free of the cells found in core 40 and, therefore have a greater density than the core 40. The thickness of the layers 36, 38 is dependent upon the cooling rate of the surfaces of the molten polymer that are in contact with the second shot mold cavity 74 and the substrate 26. Cooling the molten polymer more rapidly may increase the thickness of the layers 36, 38.

After the instrument panel 12 has cooled, the second member 64 is moved away from the core 66, and the instrument panel 12 is ejected, such as by ejector pins (not shown), from the first cavity 68. The inner layer 36 is bonded, or integrally molded, with the substrate 26, and the inner and outer layers 36, 38 and core 40 are bonded or integrally molded with each other so that the substrate 26 and cover 34 define an integral structure. In addition, the core 40 of the cover 34 includes the cellular structure. The two-shot molding process is repeated to form additional instrument panels 12.

Although not illustrated, it is understood that the second cavity 70 also is adapted to confront and mate with the first member 62, during the mating of the first cavity 68 with the second member 64, to form a second substrate (not shown) identical to the first substrate 26 by injecting molten polymer into the first shot mold chamber defined by cavities 70, 72 in the first shot of the molding operation. After injection, the mold core 66 is rotated to align the second cavity 70 with cavity 74 in the second member 64 and mated to define a second shot chamber for the second shot of the molding operation while the first cavity 68 returns to a confronting relationship with cavity 72 in the first member 62 to repeat the first shot of the molding operation. In this fashion, multiple instrument panels 12 may be serially formed in a continuous and efficient manner.

Instrument panel 12 or, at the least, cover 34 may also be formed by other multi-component molding processes known to those skilled in the art. For example, cover 34 may be formed by a co-injection molding process in which two or more molten polymers are sequentially or simultaneously injected into the same mold to form inner and outer layers 36, 38 surrounding a cellular core 40.

In another embodiment of the invention, instead of forming the score lines 42, 44, 46 in the instrument panel 12 during the molding operation, the score lines 42, 44, 46 that define the deployment door 32 may be formed in the instrument panel 12 in an additional processing step. In particular, the instrument panel 12 may be formed essentially as described above except that there are no moveable slides 78 with projecting portions 80 extending into the first and second mold chambers 76, 78. In this embodiment, when the instrument panel 12 is ejected from the mold assembly 60, the instrument panel 12 is moved to a processing station where the score lines 42, 44, 46 are formed in the instrument panel 12 through a laser scoring process, as shown in FIG. 6. As is well known in the art, laser scoring focuses a high-energy light beam that vaporizes or otherwise removes material from a workpiece, such as a plastic substrate. Using a laser scoring process, the score lines 42, 44 having, for example the H-shaped pattern, may be formed by focusing a laser beam on the back surface 30 of the substrate 26 and moving the laser in the desired H-shaped pattern. The depth of the score lines 42, 44, 46 may be controlled, for example, by controlling the amount of time the laser remains fixed on a specific location on the instrument panel 12. By varying this time, the desired depth of the score lines 42, 44, 46 may be achieved such that the deployment door 32 opens when a specified force is applied thereto. The laser scoring process may also be used to form continuous or intermittent score lines. Those of ordinary skill in the art will recognize other ways of using laser scoring to achieve the desired depth or type of the score lines.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A method of making an automotive trim assembly having an integral deployment door adapted to open when an airbag is deployed, comprising:
injection molding a first curable polymer to form a substrate including a deployment door in a first shot of a molding operation; and
injection molding a second curable polymer to form a cover on at least a portion of both the substrate and deployment door in a second shot of the molding operation, the cover including an inner and outer layer of the second polymer having a substantially non-cellular structure and a core of the second polymer having a cellular structure between the inner and outer layers.

2. The method of claim 1 further comprising:
forming at least one score line in the substrate to define the deployment door therein.

3. The method of claim 2, wherein forming the score line in the substrate further comprises:
molding the score line in the substrate during the molding operation.

4. The method of claim 3, wherein forming the score line in the substrate further comprises:
molding the score line as a continuous score line.

5. The method of claim 3, wherein forming the score line in the substrate further comprises:
molding the score line as an intermittent score line.

6. The method of claim 2, wherein forming the score line in the substrate further comprises:
laser scoring the score line in the substrate.

7. The method of claim 6, wherein forming the score line in the substrate further comprises:
laser scoring the score line as a continuous score line.

8. The method of claim 6, wherein forming the score line in the substrate further comprises:
laser scoring the score line as an intermittent score line.

9. The method of claim 2, wherein forming the score line in the substrate further comprises:
forming the score line entirely through the substrate.

10. The method of claim 2, wherein forming the score line in the substrate further comprises:
forming the score line partially through the cover.

11. The method of claim 1, wherein injection molding the second polymer further comprises:
mixing a blowing agent with the second polymer; and
allowing the blowing agent to form the cellular structure of the core.

12. A method of deploying an airbag cushion through an automotive trim assembly having a deployment door and a cover, comprising:
actuating an airbag system to expand the airbag cushion;
opening the deployment door in the trim assembly; and
using the cover to prevent the deployment door from detaching from the trim assembly.

13. The method of claim 12, wherein opening the deployment door further comprises:
tearing through the trim assembly along a first score line; and
pivoting the deployment door about a second score line in the trim assembly.
